(19) United States
(12) Patent Application Publication
(10) Pub. No.: US 2009/0193158 A1
(43) Pub. Date: Jul. 30, 2009

(54) STORAGE SYSTEM, DEVICE CONTROLLER, AND IMPROPER CABLE CONNECTION DETERMINATION METHOD

(75) Inventors: Naohiro Takeda, Kawasaki (JP); Juichi Sakai, Kawasaki (JP); Yusuke Oota, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/362,085

(22) Filed: Jan. 29, 2009

(30) Foreign Application Priority Data
Jan. 30, 2008 (JP) 2008-019415

(51) Int. Cl. G06F 3/00

(52) U.S. Cl. 710/16

(57) ABSTRACT

A storage system in which a plurality of storage device enclosures having duplicated device controllers are connected through cable connections, the storage system includes a device controller information management section that manages a state of a corresponding device controller in a storage device enclosure as device controller information, and an management section that manages the plurality of storage device enclosures, the overall management section includes an improper connection determination section that determines whether an improper connection in a cable connection between device controllers in the different storage device enclosures exists or not based on a connection state of the device controller according to a connection order of the cables, and based on the device controller information acquired from the device controller information management section corresponding to each of the device controllers.

### CROSS REFERENCES TO RELATED APPLICATIONS

This application is related to and claims priority to Japanese patent application no. 2008-019415 filed on Jan. 30, 2008 in the Japan Patent Office, the entire contents of which are incorporated by reference herein.

### FIELD

The present invention relates to a storage system, a device controller provided in the storage system, and a method for determining improper cable connection in the storage system.

### BACKGROUND

In recent years, a technique for providing a large capacity storage medium by centrally controlling access to a plurality of storage devices has been known. In such a storage system, a configuration in which a plurality of storage device enclosures having storage media are connected to a control enclosure having a circuit for processing external access has been widely used.

Furthermore, in the storage system, to increase its reliability and maintainability, access paths to the devices are duplicated. For example, a configuration in which a plurality of device enclosures having duplicated device controllers (hereinafter, referred to as Exp) are connected using Serial Attached SCSI interfaces (hereinafter, referred to as SAS interface) has been used.

In the configuration, if a cable connection between the device enclosures is improper, it is not possible to obtain the above-described duplication effect. In view of the above, techniques to detect an improper cable connection have been developed. For example, Japanese Laid-open Patent Publication No. 5-120046 discloses a detection system for detecting an improper connection of inter-device cables. In the system, with respect to main signals of a system “0” and a system “1”, operation is performed with an odd parity and the other with an even parity. When errors are detected a certain number of consecutive times, the existence of an improper cable connection can be detected.

Furthermore, in Japanese Laid-open Patent Publication No. 2006-146489, a detection method for detecting an improper cable connection is disclosed. In the method, in a configuration in which duplicated device controllers and device enclosures are connected using FC-AL interfaces, using unique IDs defined to storage disks, the unique IDs are obtained from both systems. If the unique IDs are not coincident with each other, an improper cable connection can be detected.

However, in the above-described technique disclosed in Japanese Laid-open Patent Publication No. 5-120046, the device configurations are complicated. Furthermore, in the detection method disclosed in Japanese Laid-open Patent Publication No. 2006-146489, it is necessary to provide one or more disks having the unique ID in each device enclosure to detect an improper connection.

Furthermore, in a case where individual device enclosures have their own unique IDs (DE-IDs), if the DE-IDs are allocated in a connection order, using the DE-IDs, an improper connection can be detected. However, in a case where the DE-ID decision logic depends on the connection order of the cables, it is not possible to detect an improper connection by checking the DE-IDs.

The present invention has been made to address the problems in the above-described known arts, and it is an aspect of the present invention to provide a storage system capable of detecting an improper cable connection with a simple configuration, a device controller, and a method for determining an improper cable connection.

### SUMMARY

In accordance with an aspect of the present embodiment, a storage system in which a plurality of storage device enclosures having duplicated device controllers are connected through cable connections, the storage system includes a device controller information management section that manages a state of a corresponding device controller in a storage device enclosure as device controller information, and an management section that manages the plurality of storage device enclosures, the overall management section includes an improper connection determination section that determines whether an improper connection in a cable connection between device controllers in the different storage device enclosures exists or not based on a connection state of the device controller according to a connection order of the cables, and based on the device controller information acquired from the device controller information management section corresponding to each of the device controllers.

### BRIEF DESCRIPTION OF THE DRAWINGS

FIG. 1 illustrates a schematic configuration of a storage system according to an embodiment of the present invention.

FIG. 2 illustrates a mismatch in a connection order in a system “0” and a system “1”.

FIG. 3 illustrates a SASMap in a case where a mismatch in a connection order exists.

FIG. 4 is a flowchart illustrating a connection order mismatch detection process.

FIG. 5 illustrates a cross connection in a system “0” and a system “1”.

FIG. 6 illustrates a SASMap in a case where a cross connection exists.

FIG. 7 is a flowchart illustrating a cross connection detection process.

### DESCRIPTION OF EMBODIMENTS

Hereinafter, an embodiment of a storage system, a device controller, and a method for determining an improper cable connection will be described with reference to the attached drawings.

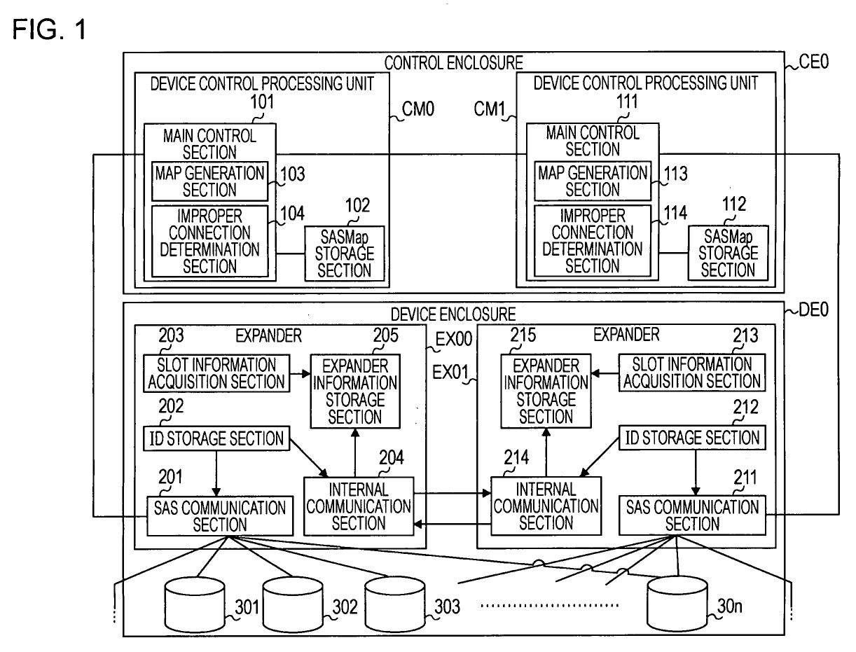

FIG. 1 illustrates a schematic configuration of a storage system. As illustrated in FIG. 1, in the storage system according to the embodiment, a plurality of storage device enclosures DE that have storage media are connected by serial cables to a control enclosure CE0 that has an external access processing function.

The control enclosure CE0 includes a device control processing unit CM0 and a device control processing unit CM1 to duplicate access paths to the device. The device control processing unit CM0 controls a system “0”, and the device control processing unit CM1 controls a system “1”.

The device control processing unit CM0 includes a main control section 101 and a SASMap storage section 102 in the unit. The main control section 101 controls entire access to the system “0”. The main control section 101 is connected by a SAS interface to an expander EX00 that is a device controller in a device enclosure DE0. Furthermore, the main control section 101 is connected to the SASMap storage section 102 and the device control processing unit CM1.

The main control section 101 includes a map generation section 103 and an improper connection determination section 104. The map generation section 103 acquires identification information and a connection order of device controllers connected by SAS interfaces, and stores the identification information in the SASMap storage section 102.

Furthermore, the map generation section 103 acquires a state of a device controller (expander) in a storage device enclosure as expander information, and stores the expander information in the SASMap storage section 102. The map generation section 103 communicates with a map generation section 113 in the main control section 111 in the device control processing unit CM1. Furthermore, the map generation section 103 compares the expander information of the system “0” acquired by the map generation section 103 with expander information of the system “1” acquired by the map generation section 113, and matches the contents of the information of both expanders.

The improper connection determination section 104 determines whether or not an improper connection exists in the cable connection based on the connection order of the device controllers and the expander information stored in the SASMap storage section 102.

The device control processing unit CM1 has a configuration similar to the device control processing unit CM0. The device control processing unit CM1 controls access to the system “1” and has functions to generate a SASMap and to perform an improper cable connection determination.

The device enclosure DE0 is a storage device enclosure that includes a plurality of storage devices 301 to 30n, and the expander EX00 and an expander EX01 that are duplicated device controllers.

The expander EX00 includes an SAS communication section 201, an ID storage section 202, a slot information acquisition section 203, an internal communication section 204, and an expander information storage section 205. The SAS communication section 201 is connected by SAS interfaces to the device control processing unit CM0, subsequent device enclosures (not shown), and each of the storage disk groups in the device enclosure DE0.

The ID storage section 202 stores an SAS address of the expander EX00 as ID information for identifying the expander EX00. The ID storage section 202 provides the ID of the expander EX00 to the SAS communication section 201 and the internal communication section 204.

The device enclosure DE0 has two slots as installation sections for installing expanders. Which expander in the system “0” or the system “1” is to be installed is determined for each slot. The slot information acquisition section 203 acquires slot information indicating to which location in the device enclosure DE0 the expander EX00 has been installed. The slot information acquisition section 203 acquires information indicating that the slot to which the expander EX00 has been installed is to be connected to the system “0” or the system “1”. The slot information acquisition section 203 stores the slot information in the expander information storage section 205 as expander information.

The internal communication section 204 in the device enclosure DE0 communicates with the expander EX01 which is another device controller that exists in the same enclosure. As a communication line used for the communication, it is preferable to use a simple interface (I2C, etc.).

The internal communication section 204 transmits the ID of the expander EX00 acquired from the ID storage section 202 to the expander EX01. Furthermore, the internal communication section 204 acquires an ID of the expander EX01 from the expander EX01, and stores the ID in the expander information storage section 205 as a pair ID that is expander information.

The configuration and operation of the expander EX01 is similar to that of the expander EX00, and accordingly, its description is omitted. Device enclosures having similar configurations are connected to the device enclosure DE0 by serial cables.

The improper connection determination section 104 in the control enclosure CE0 may detect a mismatch in a connection order in the system “0” and the system “1” using pair IDs from the expander information. The improper connection determination section 104 may also detect a cross connection in the system “0” and the system “1” using the slot information.

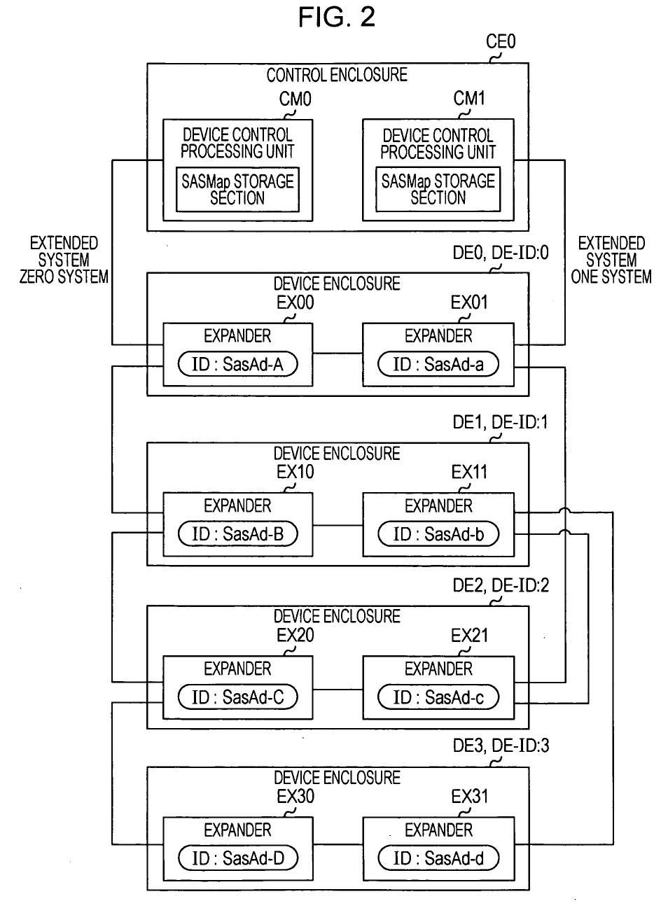

FIG. 2 is a explanatory view for explaining a mismatch in a connection order in a system “0” and a system “1”. In the configuration illustrated in FIG. 2, the device enclosure DE0, the device enclosure DE1, a device enclosure DE2, and a device enclosure DE3 are connected in order by SAS cables in the system “0” which has the device control processing unit CM0 as a starting point.

Meanwhile, the device enclosure DE0, the device enclosure DE2, the device enclosure DE1, and the device enclosure DE3 are connected in order by SAS cables in the system “1” which has the device control processing unit CM1 as a starting point. Therefore, a mismatch exists in the connection orders.

In the device enclosure DE0, an ID (SAS address) of the expander EX00 is SasAd-A, and an ID of the expander EX01 is SasAd-a. In the device enclosure DE1, an ID of an expander EX10 is SasAd-B, and an ID of an expander EX11 is SasAd-b. In the device enclosure DE2, an ID of an expander EX20 is SasAd-C, and an ID of an expander EX21 is SasAd-c. In the device enclosure DE3, an ID of an expander EX30 is SasAd-D, and an ID of an expander EX31 is SasAd-d.

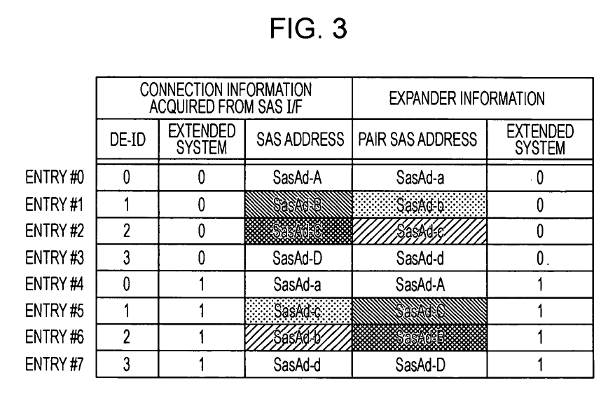

The map generation sections 103 and 113 generate entries in a SASMap in the order of the extended system “0” and system “1”. Then, as illustrated in FIG. 3, in connection information acquired from the SAS interfaces, the SAS addresses are arranged in the order of “SasAd-A”, “SasAd-B”, “SasAd-C”, “SasAd-D”, “SasAd-a”, “SasAd-c”, “SasAd-b”, and “SasAd-d”. That is, in the system “0”, the addresses are arranged in the order of “ABCD”. However in the system “1”, the addresses are arranged in the order of “acbd”.

In the pair IDs (pair SAS addresses) in the expander information, SAS addresses of expanders exist in the same enclosures where the individual expanders are stored. Accordingly, the pair SAS addresses are arranged in the order of “SasAd-a”, “SasAd-b”, “SasAd-c”, “SasAd-d”, “SasAd-A”, “SasAd-C”, “SasAd-B”, and “SasAd-D”.

If the entry #1 in the SASMap illustrated in FIG. 3 is checked, “SasAd-B” is registered as the SAS address of the expander of the system “0” in the device enclosure (secondly connected device enclosure) having DE-ID:1. Address “SasAd-b” of the expander in the same enclosure is registered as the pair SAS address.

Meanwhile, in the entry #5 in the SASMap illustrated in FIG. 3, “SasAd-c” is registered as the SAS address of the expander of the system “1” in the device enclosure having DE-ID:1, that is, the device enclosure secondly connected. Address “SasAd-C” of the expander in the same enclosure is registered as the pair SAS address.

If the cables of the expanders are correctly connected, the entry #1 and the entry #5 indicate the same enclosure, and the pair SAS address of the entry #1 is the same as the SAS address of the entry #5. However, in the above case, a mismatch of the addresses exists. Accordingly, it is possible to determine that a mismatch exists in the cable connection order.

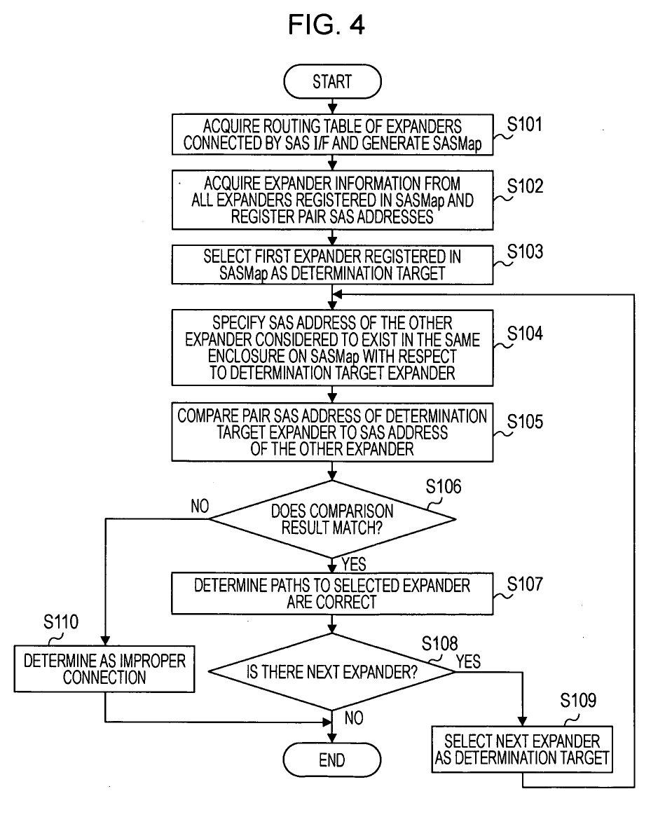

FIG. 4 is a flowchart illustrating a connection order mismatch detection process. Before the mismatch detection operation is started, it is assumed that expanders that are duplicated in a device enclosure report own SAS addresses to the other expanders connected by an I2C bus, or the like, at the time of startup, and store the addresses in expander information regions as pair SAS addresses respectively.

As illustrated in FIG. 4, at the time of startup of device control processing units, the map generation section 103 in the CM0 acquires a routing table of SAS devices (expanders) connected by SAS interfaces, and generates a SASMap (operation S101). The routing table is a table that stores identification information for controlling access to storage media included in each device enclosure.

The map generation section 103 acquires information of expander information regions from all expanders registered in the SASMap, and registers pair SAS addresses (operation S102). To acquire the expander information, SAS interfaces or other inter-enclosure cables may be used.

The improper connection determination section 104 selects an expander indicated in a first entry registered in the SASMap as an improper connection determination target (operation S103). The improper connection determination section 104, with respect to the determination target expander, specifies the SAS address of the other expander that is considered to exist in the same enclosure (operation S104) based on the DE-ID on the SASMap, that is, based on an actual connection order of the SAS cables.

Furthermore, the improper connection determination section 104, with respect to the determination target expander, compares the SAS address of the other expander to the pair SAS address of the determination target expander (operation S105).

As a result of the comparison, if the comparison result does not match (NO in operation S106), the improper connection determination section 104 determines that an improper connection exists in the cable connection of the determination target expander (operation 110), and the process ends.

On the other hand, if the comparison result matches (YES in operation S106), the paths to the expander selected as the determination target are determined to be correct (operation S107). Then, whether the next expander exists or not is determined (operation S108). If the next expander exists (YES in operation S108), the next expander is selected as the determination target (operation S109), and the operations from operation S104 are repeated.

If the determination is performed on all expanders, and the next expander does not exist (NO in operation S108), the process ends.

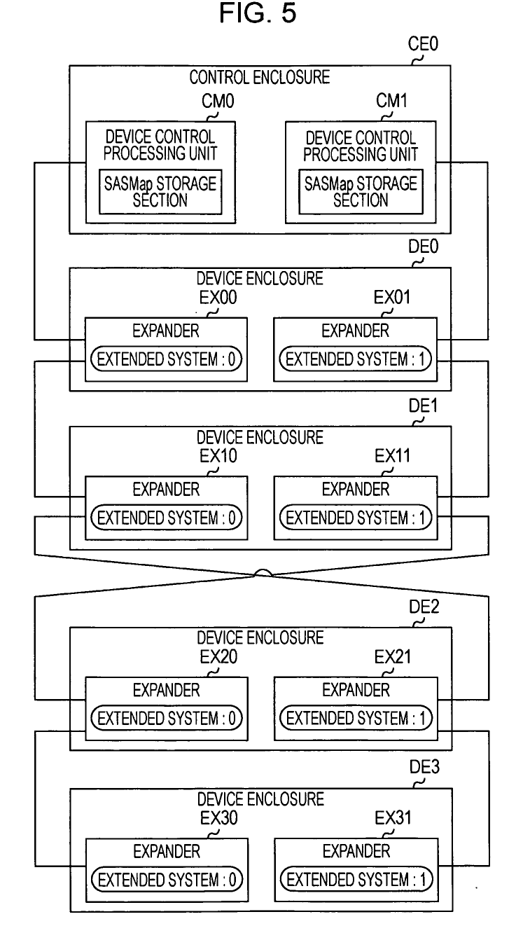

Now, a cross connection in the system “0” and the system “1” is described with reference to FIG. 5. In the configuration illustrated in FIG. 5, the control enclosure CE0, the device enclosure DE0, the device enclosure DE1, the device enclosure DE2, and the device enclosure DE3 are connected by serial cables.

The expander EX00 in the device enclosure DE0, the expander EX10 in the device enclosure DE1, the expander EX20 in the device enclosure DE2, and the expander EX30 in the device enclosure DE3 are installed to slots to be used for the extended system “0”, respectively. Similarly, the expander EX01 in the device enclosure DE1, the expander EX11 in the device enclosure DE1, the expander EX21 in the device enclosure DE2, and the expander EX31 in the device enclosure DE3 are installed in slots to be used for the extended system “1”, respectively.

However, in the cable connection illustrated in FIG. 5, connections between the device enclosure DE1 and the device enclosure DE2 are crossed. In the connections, in the device enclosures DE2 and DE3, the expanders EX21 and EX31 to be connected to the system “1” are connected to the system “0”, and the expanders EX20 and EX30 to be connected to the system “0” are connected to the system “1”.

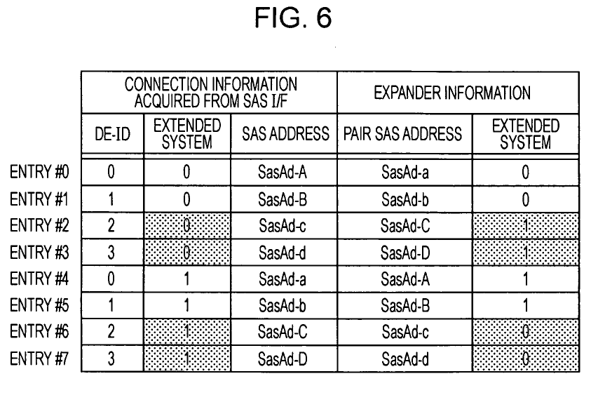

If entries in the SASMap are created in the order of the system “0” and the system “1”, the extended systems are arranged in the order of “0”, “0”, “0”, “0”, “1”, “1”, “1”, “1” as illustrated in FIG. 6 in the column “Connection information acquired from the SAS I/F”.

In the extended system in the expander information, information about to which slot each expander is installed is stored. Accordingly, the extended systems are arranged in the order of “0”, “0”, “1”, “1”, “1”, “1”, “0”, “0”.

If the entry 2 in the SASMap illustrated in FIG. 6 is checked, the extended system acquired from the SAS interface indicates “0”, and the extended system in the expander information indicates “1”. If the cables of the expanders are correctly connected, the value of the extended system acquired from the SAS interface and the value in the extended system in the expander information with respect to each entry becomes the same value. However, in the above-described case, a mismatch exists. Accordingly, it can be determined that a cross connection of the SAS cables exists.

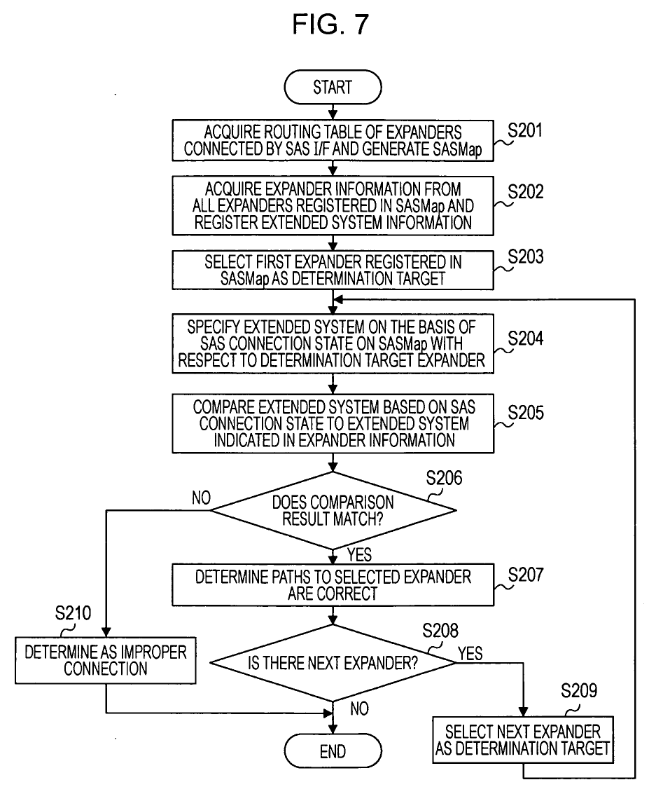

FIG. 7 is a flowchart illustrating a cross connection detection process. Before the process is started, it is assumed that each expander acquires slot position information (system “0”/system “1”) from a programmable logic device (PLD) in an enclosure at the time of startup, and stores the information in an expander information region as an extended system.

As illustrated in FIG. 7, at the time of startup of the device control processing units, the map generation section 103 in the CM0 acquires a routing table of SAS devices (expanders) connected by SAS interfaces, and generates an SASMap (operation S201).

The map generation section 103 acquires information of expander information regions from all expanders registered in the SASMap, and registers extended system information (operation S202). To acquire the extended system information, SAS interfaces or other inter-enclosure cables can be used.

The improper connection determination section 104 selects an expander indicated in a first entry registered in the SASMap as an improper connection determination target (operation S203). The improper connection determination section 104 specifies to which of the extended system “0” or the extended system “1” the determination target expander belongs on the basis of an actual connection order of the SAS cables on the SASMap, with respect to the determination target expander (operation S204).

Furthermore, the improper connection determination section 104 compares the extended system based on the SAS connection state to the extended system information stored as the expander information with respect to the determination target expander (operation S205).

As a result of the comparison, if the comparison result does not match (NO in operation S206), it is determined that a cross connection exists in the cable connections of the determination target expander (operation S210), and the process ends.

On the other hand, if the comparison result matches (YES in operation S206), the improper connection determination section 104 determines that paths to the expander selected as the determination target are correct (operation S207). Then, whether the next expander exists or not is determined (operation S208). If the next expander exists (YES in operation S208), the next expander is selected as the determination target (operation S209), and operations from operation S204 are repeated.

If the determination is performed on all expanders, and the next expander does not exist (NO in operation S208), the process ends.

As described above, in the storage system according to the embodiment of the present invention, expanders duplicated in a device enclosure may be interconnected using simple interfaces such as I2C buses other than SAS interfaces. Then, the expanders set each other's SAS addresses that are unique IDs of the individual expanders as expander information (pair information) via inter-enclosure buses. The device control processing units (CM0 and CM1) acquire the information from the expanders to clarify pair states in the device enclosure. Meanwhile, the device control processing units compare SAS addresses registered in SAS device connection information (SASMap) created in a routing table of the SAS devices and check whether the results do not contradict the pair state in the device enclosure to detect an improper connection.

Furthermore, information indicating to which slot to be connected to the system “0” or the system “1” each expander is installed is set as the expander information, and extended systems indicated by the installation slots are compared to actually cable-connected extended systems to detect a cross connection.

Accordingly, a storage system that can detect a mismatch in a connection order in the system “0” and the system “1” or a cross connection in the system “0” and the system “1” in a cable connection with a simple configuration, a device controller, and an improper cable connection determination method can be achieved.

As described above, although the embodiment of the present invention has been described in detail, it is to be understood that the present invention is not limited to the specific embodiment, but various modifications and changes may be made within the scope of the invention.

What is claimed is:

1. A storage system in which a plurality of storage device enclosures having duplicated device controllers are connected through cable connections, the storage system comprising:
a device controller information management section that manages a state of a corresponding device controller in a storage device enclosure as device controller information; and
an management section that manages the plurality of storage device enclosures, the overall management section includes an improper connection determination section that determines whether an improper connection in a cable connection between device controllers in the different storage device enclosures exists or not based on a connection state of the device controller according to a connection order of the cables, and based on the device controller information acquired from the device controller information management section corresponding to each of the device controllers.

2. The storage system according to claim 1,
wherein, the device controller information includes identification information of the other device controller in the same enclosure, and the improper connection determination section determines whether an improper connection exists or not on the basis of whether a cable connection order of the duplicated systems matches a cable connection order estimated on the basis of the identification information of the other device controller.

3. The storage system according to claim 1,
wherein, the device controller information includes information on whether an installation position of a device controller that corresponds to any cable connection of the duplicated systems is a proper installation position, and the improper connection determination section determines whether an improper connection exists or not based on whether an actual connection indicated by the cable connection order matches the system to be connected indicated by the installation position.

4. A device controller installed in a storage device enclosure is connected to the other enclosures by cables, and forms a redundant configuration with the other device controller in the same enclosure, the device controller comprising:
an internal communication section for acquiring identification information of the other device controller in the same enclosure; and
a device controller information management section for managing the information acquired by the internal communication section as device controller information, and for providing the device controller information to an overall management section that manages a plurality of storage device enclosures.

5. A device controller installed in a storage device enclosure is connected to the other enclosures by cables, and forms a redundant configuration with the other device controller in the same enclosure, the device controller comprising:
an installation information acquisition section for acquiring information indicating on which installation section to install a device controller corresponding to any of the cable connections of the duplicated systems the device controller is installed; and
a device controller information management section for managing the information acquired by the installation information acquisition section as device controller information, and providing the device controller information to an overall management section for managing a plurality of storage device enclosures.

6. An improper cable connection determination method in a storage system in which a plurality of storage device enclosures having duplicated device controllers are interconnected by cables, the method comprising:
managing, by each device controller, a state of the own device controller as device controller information; and
determining whether an improper connection in the cable connection exists or not on the basis of a connection state of the device controller based on a connection order of the cables and the device controller information.

7. The improper cable connection determination method according to claim 6,
wherein, the device controller information comprises identification information of the other device controller in the same enclosure, and the determining step determines whether an improper connection exists or not on the basis of whether a cable connection order in the duplicated systems matches a cable connection order estimated on the basis of the identification information of the other device controller.

8. The improper cable connection determination method according to claim 6,
wherein, the device controller information includes information on whether an installation position of a device controller that corresponds to any cable connection of the duplicated systems is a proper installation position, and the determining step determines whether an improper connection exists or not on the basis of whether an actual connected system indicated by the cable connection order matches the system to be connected indicated by the installation section.
